(19) United States
(12) Patent Application Publication
(10) Pub. No.: US 2003/0005584 A1
(43) Pub. Date: Jan. 9, 2003

(54) Assembly including heat pipe and heat conductive member fixed to each other by plastic deformation of the latter, and method of manufacturing the assembly

(75) Inventors: Noritoshi Komatsu, Minato-Ku (JP); Osamu Aoya, Minato-Ku (JP); Takehiro Chinen, Minato-Ku (JP); Tadashi Katsui, Kawasaki-Shi (JP); Yoshiaki Udagawa, Kawasaki-Shi (JP)

Correspondence Address: BURR & BROWN, PO BOX 7068, SYRACUSE, NY, 13261-7068, US

(73) Assignee: Sumitomo Light Metal Industries, Ltd., Minato-Ku (JP)

(21) Appl. No.: 10/184,862

(22) Filed: Jun. 27, 2002

Related U.S. Application Data
(62) Division of application No. 09/419,454, filed on Oct. 15, 1999.

(30) Foreign Application Priority Data
Nov. 20, 1998 (JP) 10-330690

(51) Int. Cl. B23P 6/00

(52) U.S. Cl. 29/890.032

(57) ABSTRACT

An assembly including at least one heat conductive member each constituted by an aluminum-based die-casting, and a heat pipe attached at a fixing portion thereof to the heat conductive member. The assembly is characterized in that the aluminum-based die-casting is formed of a castable aluminum alloy which includes up to 0.5% by weight of silicon; that the heat conductive member has a groove formed in a surface thereof; and that the heat pipe is accommodated at the fixing portion in the groove, and is held fixed at the fixing portion in the groove by plastically deforming at least one of opposite side walls defining the groove, toward an outer circumferential surface of the heat pipe.

The present application is based on Japanese Patent Application No. 10-330690 filed Nov. 20, 1998, the content of which is incorporated hereinto by reference.

### BACKGROUND OF THE INVENTION

1. Field of the Invention

The present invention relates in general to an assembly including a heat conductive member constituted by an aluminum-based die-casting and a heat pipe attached at a fixing portion thereof to the heat conductive member over a predetermined length, and also a method of manufacturing the assembly.

2. Discussion of the Related Art

There is known a heat pipe which is an elongated tube charged with a small amount of a volatile working fluid. Latent heat is absorbed by evaporation of the fluid and is then dissipated by condensation of the vapor, whereby the heat pipe achieves a heat transfer. Since the heat pipe is capable of transferring a large amount of heat with a little heat loss even where a temperature difference within the heat pipe is small, the heat pipe has been applied to a heat dissipator, a heat exchanger or other device to which heat is directed. In recent years, the heat pipe is used also for cooling a computer or other electronic device.

Such a heat pipe includes a heat absorbing portion having a predetermined length, and a heat dissipating portion having a predetermined length and distant from the heat absorbing portion by a predetermined distance. A heat absorbing member is attached to the heat absorbing portion, while a heat dissipating member is attached to the heat dissipating portion, so that the heat pipe and the heat absorbing and dissipating members cooperate to provide a single assembly in which heat transfer between the heat absorbing and dissipating portions is effectively achieved. The heat absorbing and dissipating members, i.e., heat conductive members tend to have complicated shapes so as to have the required heat absorbing or dissipating capacity. Particularly, a heat sink, which is a kind of the heat dissipating member, has a considerably complicated shape. It is, therefore, preferable that the heat sink or other heat conductive member be formed in a die casting process, so that the heat conductive member having the complicated shape can be efficiently produced with high configurational or geometrical accuracy. Further, it is advantageous that the heat conductive member be made of an aluminum-based die-casting which is formed of an aluminum material characterized by its high thermal or heat conductivity and its light weight.

For maximizing the thermal conductivity between the heat pipe and the heat conductive member, the heat pipe and the heat conductive member have to be fixed to each other in a manner that maximizes the surface area of contact with each other. To this end, the heat pipe and the heat conductive member are fixed to each other, such that the heat pipe is bonded, by an adhesive, in a groove formed in the heat conductive member, or alternatively, such that the heat pipe is gripped between the heat conductive member and a retainer plate which are fixed to each other by bolts or other suitable fastening means.

However, these conventional methods of fixing the heat pipe to the heat conductive member suffer from various problems. The method using the bonding adhesive requires a cumbersome operation for applying the adhesive in the groove so as to fix the heat pipe in the groove, resulting in a poor working efficiency in fixing the heat pipe to the heat conductive member. The method using the retainer plate requires a space adjacent to a selected portion of the heat conductive member so that the retainer plate is attached to that selected portion. This requirement limits the freedom in selecting a specific position at which the heat pipe is fixed to the heat conductive member, or makes it impossible to attach the heat pipe to the heat conductive member if a sufficient space is not available adjacent to a suitable portion of the heat conductive member, for the attachment of the retainer plate to the heat conductive member. Even if the heat pipe can be attached to the heat conductive member with the retainer plate, the heat pipe is not attached directly to the heat conductive member but is attached through the retainer plate with suitable fastening means being located at some points, thereby resulting in an insufficient structural rigidity in the obtained assembly structure, and also an insufficient surface area of contact and unsatisfactory thermal conductivity between the heat pipe and the heat conductive member.

There is generally known a method of fixing two independent members to each other, in which a portion of one of the two members is caulked, crimpted or otherwise plastically deformed or permanently bent into pressing or gripping engagement or contact with the other member. This method of fixing two members by the plastic deformation may be practiced to fix the heat pipe to the heat conductive member. However, where the heat conductive member is constituted by an aluminum-based die-casting, as described above, the heat conductive member may fracture or crack at the bent portion, thereby making it impossible to assuredly firmly fix the heat pipe to the heat conductive member. That is, the fracture or crack of the bent portion makes it difficult to fix the heat conductive member to the heat pipe such that the heat pipe is held in close contact at a portion thereof with the heat conductive member over a predetermined length. As a consequence, the assembly does not exhibit satisfactory thermal conductivity.

### SUMMARY OF THE INVENTION

It is therefore a first object of the present invention to provide an assembly in which a heat conductive member permits a heat pipe to be easily, efficiently and firmly attached to the heat conductive member by plastic deformation of the heat conductive member, and more particularly such an assembly in which the heat pipe is attached directly to the heat conductive member constituted by an aluminum-based die-casting, by plastically deforming the heat conductive member, thereby assuring satisfactory thermal conductivity between the heat pipe and the heat conductive member, and an increased freedom in selecting a portion of the heat conductive member to which the heat pipe is attached.

It is a second object of the invention to provide a method of manufacturing the assembly constructed according to the invention.

The above first object may be achieved according to any one of the following modes of the present invention, which are numbered, and are dependent from each other, where appropriate, like the appended claims, to indicate possible combinations of elements or features in preferred forms of the present invention.

(1) An assembly comprising at least one heat conductive member each constituted by an aluminum-based die-casting, and a heat pipe attached at a fixing portion thereof to the heat conductive member over a predetermined length, the assembly being characterized in that;

the aluminum-based die-casting being formed of a castable aluminum alloy which includes up to 0.5% by weight of silicon;

the heat conductive member having a groove formed in a surface thereof; and

the heat pipe being accommodated at the fixing portion in the groove, and being held fixed at the fixing portion in the groove by plastically deforming at least one of opposite side walls defining the groove, toward an outer circumferential surface of the heat pipe.

In the assembly constructed according to the present mode of the invention, the aluminum-based die-casting which constitutes at least one heat conductive member (i.e., heat absorbing member and/or heat dissipating member) is formed of the castable aluminum alloy having a content of the silicon in a range not higher than 0.5% by weight. This upper limit of the silicon content permits the side wall or walls of the groove to be permanently bent toward the outer circumferential surface of the heat pipe, so that the heat pipe is fixed directly to the heat conductive member without a retainer plate or any other additional component interposed therebetween, thereby resulting in an improved performance of the heat transfer between the heat pipe and the heat conductive member, and also an increased freedom in selecting a portion of the heat conductive member to which the heat pipe is attached. Although chemical components other than silicon and aluminum of the above-described castable aluminum alloy are not specifically limited, it is preferable that the castable aluminum alloy further includes: both of Fe and Mn; at least one of Zn and Cu; and additionally, at least one of Mg, Ti, W, Ni and Sn.

(2) An assembly according to mode (1), wherein the groove has a bottom shape corresponding to a shape of the circumferential surface of the heat pipe such that an inner surface of the groove is held in contact with the outer circumferential surface of the heat pipe over at least a half of a circumference of the heat pipe.

In the assembly according to this mode (2), the groove has a cross sectional shape corresponding to that of the heat pipe, thereby further increasing the surface area of contact between the heat pipe and the heat conductive member and assuring an accordingly improved performance of the heat transfer between the heat pipe and the heat conductive member.

(3) An assembly according to mode (1) or (2), wherein each of the at least one of opposite side walls of the groove is constituted by a tab which is bent down onto the outer circumferential surface of the heat pipe.

In the assembly according to this mode (3), the tab preferably has a suitable thickness permitting the tab to be sufficiently bent down so as to firmly hold the heat pipe in contact with its outer circumferential surface, without fracturing or cracking of the tab. Thus, it is possible to further increase the structural rigidity of the assembly. The tab may protrude over a predetermined distance from the surface in which the groove is formed.

(4) An assembly according to any one of modes (1)-(3), wherein the at least one heat conductive member comprises a heat absorbing member.

(5) An assembly according to any one of modes (1)-(4), wherein the at least one heat conductive member comprises a heat dissipating member.

(6) An assembly according to mode (5), wherein the heat dissipating member is a heat sink.

The present invention is advantageously applicable to an assembly wherein the heat conductive member includes or consists of a heat sink, since the heat sink is preferably or can be easily constituted by an aluminum-based die-casting. That is, the heat sink usually or necessarily has a complicated shape or configuration so as to have the required heat dissipating capacity. It is technically advantageous to use an aluminum-based die-casting to manufacturing the heat sink having the complicated shape. Further, the use of the aluminum-based die-casting is also technically advantageous to increase the freedom in selecting the portion of the complicatedly-shaped heat sink to which the heat pipe is attached. This increased freedom permits the assembly to be made simple in construction and compact in size.

(7) An assembly according to mode (6), wherein the heat sink has a generally plate-like shape and a peripheral surface which defines a periphery of the plate-like shape, and wherein the groove is formed in the peripheral surface and extends over a predetermined length along the periphery.

The present invention is advantageously applicable to an assembly wherein the heat pipe is fixed to the heat sink having the generally plate-like shape and the groove is formed in the peripheral surface of the plate-like heat sink over the predetermined length along the periphery of the heat sink.

(8) An assembly according to any one of modes (1)-(7), wherein the castable aluminum alloy includes up to 0.1% by weight of silicon.

The above-described second object may be achieved according to any one of the following modes of the present invention, which are numbered and dependent from each other, like the appended claims, to indicate possible combinations of elements or features in preferred forms of the present invention.

(9) A method of manufacturing an assembly including a heat conductive member constituted by an aluminum-based die-casting, and a heat pipe attached at a fixing portion thereof to the heat conductive member over a predetermined length, the method being characterized by comprising;

a step of preparing the heat conductive member by forming the aluminum-based die-casting of a castable aluminum alloy such that the heat conductive member has a groove in a surface of the heat conductive member, the castable. aluminum alloy including up to 0.5% by weight of silicon;

a step of preparing the heat pipe;

a step of accommodating the heat pipe at the fixing portion in the groove; and

a step of plastically deforming at least one of opposite side walls defining the groove, toward an outer circumferential surface of the heat pipe, so that heat pipe and the heat conductive member are fixed to each other so as to provide the assembly.

(10) A method according to mode (9), wherein the groove has a bottom shape corresponding to a shape of the circumferential surface of the heat pipe such that an inner surface of the groove is held in contact with the outer circumferential surface of the heat pipe over at least a half of a circumference of the heat pipe.

(11) A method according to mode (9) or (10), further comprising a step of forming a tab at at least one of opposite edges of the groove such that the tab protrudes over a predetermined distance from the surface in which the groove is formed, so that the at least one of the opposite side walls is constituted by the tab, and wherein the tab is bent down onto the outer circumferential surface of the heat pipe.

(12) A method according to any one of modes (9)-(11), wherein the heat conductive member has a generally plate-like shape and a peripheral surface which defines a periphery of the plate-like shape, and wherein the groove is formed in the peripheral surface and extends over a predetermined length along the periphery.

(13) A method according to any one of modes (9)-(12), wherein the castable aluminum alloy includes up to 0.1% by weight of silicon.

(14) A method of according to any one of modes (9)-(13), further comprising a step of machining the groove in the surface of the heat conductive member.

In the method according to this mode (14), the groove is machined, for example, after the above-described step of preparing the heat conductive member, whereby dimensional accuracy of the groove is further improved. In a method according to combination of mode (10) and this mode (14), the formed groove is machined so that the bottom shape further accurately corresponds to the outer shape of the heat pipe, whereby the inner surface of the groove is further assuredly held in contact with the contact surface of the heat pipe.

The present invention also provides a heat conductive member constituted by an aluminum-based die-casting and attached to a fixing portion of a heat pipe over a predetermined length. The heat conductive member is characterized in that the aluminum-based die-casting is formed of a castable aluminum alloy which includes up to 0.5% by weight of silicon, that the heat conductive member has a groove formed in a surface thereof, and that the heat pipe is accommodated in the groove and is held fixed at the fixing portion in the groove by plastically deforming at least one of opposite side walls defining the groove, toward an outer circumferential surface of the heat pipe.

### BRIEF DESCRIPTION OF THE DRAWINGS

The above and optional objects, features, advantages and technical and industrial significance of the present invention will be better understood by reading the following detailed description of presently preferred embodiments of the invention, when considered in connection with the accompanying drawings, in which:

FIG. 1(a) is a plan view showing a heat transfer or cooling assembly constructed according to an embodiment of the present invention, in which a heat pipe, a heat absorbing block and a heat sink are fixed to each other;

FIG. 1(b) is a front view showing the heat transfer assembly of FIG. 1(a);

FIG. 1(c) is a left side view showing the heat transfer assembly of FIG. 1(a);

FIG. 1(d) is a right side view showing the heat transfer assembly of FIG. 1(a);

FIG. 2(a) is a plan view showing a main body of the heat sink which constitutes a part of the heat transfer assembly of FIG. 1;

FIG. 2(b) is a front view showing the main body of the heat sink of FIG. 2(a);

FIG. 2(c) is a left side view showing the main body of the heat sink of FIG. 2(a);

FIG. 2(d) is a right side view showing the main body of the heat sink of FIG. 2(a);

FIG. 3(a) is an enlarged fragmentary view in cross section showing plastic deformation or bending of a portion of the main body of the heat sink of FIG. 1 onto the heat pipe, for fixing the heat pipe to the heat sink;

FIG. 3(b) is an enlarged fragmentary view in cross section showing plastic deformation or bending of a portion of the heat absorbing block of FIG. 1 onto the heat pipe, for fixing the heat pipe to the heat absorbing block;

FIGS. 4(a)-(f) are enlarged fragmentary views in cross section showing various forms of construction for fixing the heat pipe and the heat absorbing block or heat sink to each other by bending a tab or tabs into contact with the heat pipe accommodated in a groove formed in the heat absorbing block or heat sink;

FIGS. 5(a)-(e) are enlarged fragmentary views in cross section showing various forms of construction for fixing the heat pipe and the heat absorbing block or heat sink to each other, where the heat pipe has an elliptic shape in its cross section, by bending the tab or tabs into contact with the heat pipe accommodated in an elliptic groove formed in the heat absorbing block or heat sink;

FIG. 6(a) is a plan view showing a heat transfer assembly constructed according to another embodiment of the present invention, in which a heat pipe, a heat absorbing block and two heat sinks are fixed to each other;

FIG. 6(b) is a cross sectional view taken along line (b)-(b) of FIG. 6(a); and

FIG. 6(c) is a cross sectional view taken along line (c)-(c) of FIG. 6(a).

### DETAILED DESCRIPTION OF THE PREFERRED EMBODIMENTS

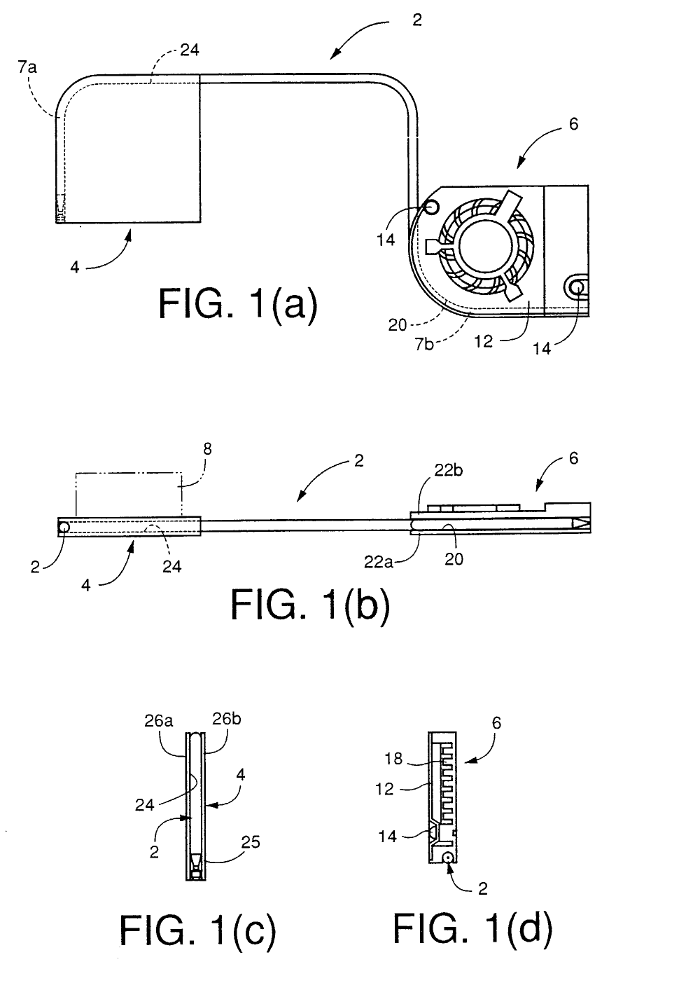

Referring first to FIG. 1, there is shown a cooling or heat transfer assembly constructed according to an embodiment of the present invention. The heat transfer assembly includes a heat pipe 2, a heat absorbing block 4 and a heat sink 6 which are fixed to each other. The heat absorbing block 4 serving as a heat absorbing member is attached to one end portion 7a of the heat pipe 2, while the heat sink 6 serving as a heat dissipating member is attached to the other end portion 7b of the heat pipe 2. The opposite end portions 7a, 7b of the heat pipe 2 respectively serve as fixing portions at which the heat pipe 2 is attached to the heat absorbing block 4 and the heat sink 6, respectively. Heat generated by a heat source or heat generating body 8 which is disposed on the heat absorbing block 4 is conducted through the heat absorbing block 4 to the heat pipe 2, and is then transferred by a heat transfer function of the heat pipe 2, to the heat sink 6 where the heat is dissipated.

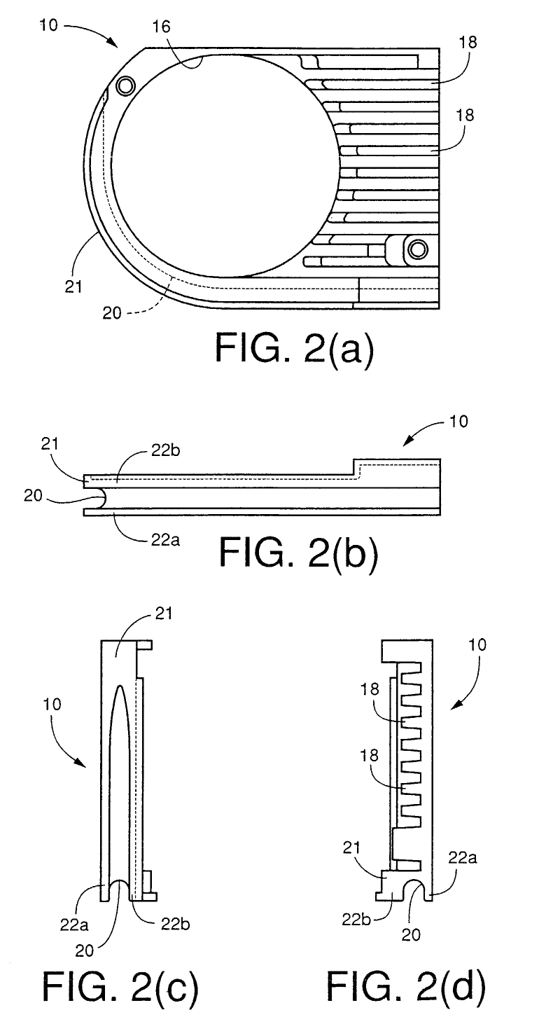

The heat sink 6 has a generally plate-like shape with a comparatively large thickness, and includes a main body 10 and a covering member 12 which substantially houses and supports an electrically driven fan, as shown in FIGS. 1 and 2. The main body 10 and the covering member 12 are superposed on each other and attached to each other through suitable screws 14. The fan is driven with an electric current supplied thereto from an external power source, for thereby causing air flows so that the heat is efficiently dissipated into the environment. As shown in FIG. 2(a), the main body 10 has at its center a hole 16 having a large diameter for accommodating the fan, and a multiplicity of fins 18 parallel to each other and serving to guide the air flows caused by the driven fan. Thus, the main body 10 has, as a whole, a considerably complicated shape.

Due to the complicated shape of the main body 10 as described above, it is preferable that the main body 10 of the heat sink 6 be formed in a die casting process, rather than in a cold forging process or a machining process, so that the main body 10 can be efficiently produced with high configurational or geometrical accuracy. Further, it is preferable that the main body 10 be constituted by an aluminum-based die-casting so that the main body 10 has a high degree of thermal conductivity and a light weight. However, if the main body of the heat sink is formed of AA(Aluminum Association)-B380.0, AA-383.0 or other castable aluminum alloy which is conventionally used as a material for the aluminum based die-casting, the main body cannot be crimped, caulked, bent or otherwise plastically deformed without fracturing or cracking. A study made by the inventors of the present invention revealed that a plastically deformed or bent portion of the main body formed of the conventional castable aluminum alloy suffers from a fracture or crack.

According to the present embodiment of the invention, the main body 10 of the heat sink 6 is constituted by an aluminum-based die-casting which is formed of a castable aluminum alloy whose content of silicon is not greater than 0.5% by weight, thereby making it possible to effectively and firmly fix the heat pipe 2 to the heat sink 6 by plastically deforming or bending over a portion of the main body 10, as specifically described below.

In other words, according to the invention, the main body 10 is constituted by the aluminum-based die-casting which is formed of the castable aluminum alloy whose content of silicon is lower than or equal to 0.5% by weight, or more preferably lower than or equal to 0.1% by weight, whereby the main body 10 is plastically deformable or permanently bent without fracturing or cracking. If the main body of the heat sink is formed of a castable aluminum alloy whose content of silicon is higher than 0.5% by weight, the main body may fracture or crack in a bent portion thereof, resulting in difficulty in fixing the heat pipe to the heat sink as needed. It is noted that the castable aluminum alloy used for forming the main body 10 preferably includes also Cu, Mg, Zn, Fe, Mn, Ni, Sn, W, and Ti, which are added to the conventional castable aluminum alloy in respective suitable amounts, for thereby increasing fluidity of the castable aluminum alloy in a molten state and preventing the molten alloy from sticking to the surface of a mold cavity, so that the casting operation is improved during die casting, or so that the mechanical properties of the die-casting are improved. Preferable upper limits of the content of the above-described components in the castable aluminum alloy are 2.0 wt % of Cu; 2.0 wt % of Mg; 3.0 wt % of Zn; 2.0 wt % of Fe; 3.0 wt % of Mn; 1.0 wt % of Ni; 0.5 wt % of Sn; 0.5 wt % of W; and 0.1 wt % of Ti. It is noted that the lower limit of silicon is a minimum detectable percent by weight, and that the lower limit of the content of each of these components is also a minimum detectable percent by weight.

The main body 10, which is constituted by the aluminum-based die-casting formed of the castable aluminum alloy as specified above, has a groove 20 formed in a portion of a peripheral surface 21 thereof. The peripheral surface 21 is parallel to the direction of thickness of the main body 10 (heat sink 6), and defines a substantially rectangular periphery of the main body 10, as seen in the plan view of FIG. 2(a). The groove 20 extends over a predetermined length along the periphery of the main body 10. As is apparent from FIGS. 1 and 2, the groove 20 consists of two straight portions and a curved portion which connects these two straight portions, and accordingly has a generally J or L shape as viewed in the plan view of the main body 10. The groove 20 has a U shape in its transverse cross section, namely, a semi-circular bottom shape which corresponds to a circular outer circumferential shape of the heat pipe 2, as in FIGS. 2(b), 2(c) and 2(d). The opposite two sides or arms of the U shape of the groove 20 are provided by respective side walls which are respectively constituted by a comparatively thin-walled tab 22a and a comparatively thick-walled tab 22b. These tabs 22a, 22b have end faces provided by the peripheral surface 21 of the main body 10, and extend along the peripheral surface 21, so as to define the groove 20. Thus, each of the opposite side walls defining the groove 20 is constituted by a corresponding one of the tabs 22a, 22b.

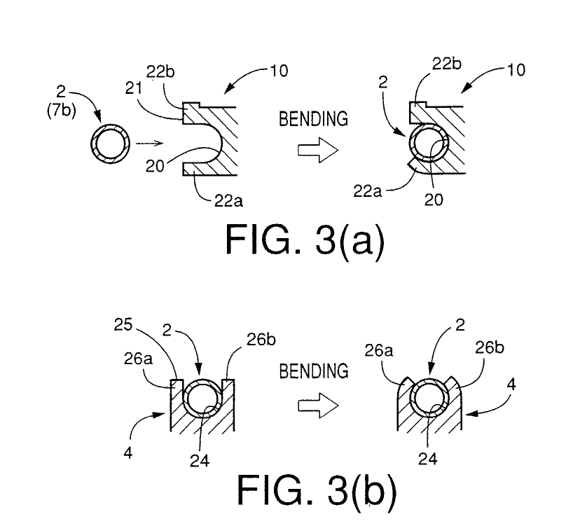

The fixing portion 7b of the heat pipe 2 is accommodated in the groove 20 thus formed in the outer peripheral surface 21 of the main body 10, as shown in FIGS. 1(a)-(d). At least one of the tabs 22a, 22b is plastically deformed, namely, bent down onto the heat pipe 2 over the entire length of the groove 20, so that the heat pipe 2 is fixed at its fixing portion 7b to the main body 10 with the inner surface of the groove 20 being in contact over a substantially entire length thereof with at least a half of a circumference of the pipe 2. In this embodiment, only the comparatively thin-walled tab 22a is caulked or bent down into heat conducting and pressing contact with the heat pipe 2 such that the heat pipe 2 is firmly held in the groove 20, while the comparatively thick-walled tab 22b serves as an engaging tab to be held in engagement with the covering member 12, as shown in FIG. 3(a). The tab 22b has a shoulder for engagement with the covering member 12.

Since the main body 10 is constituted by the aluminum-based die-casting which is formed of the castable aluminum alloy whose content of silicon is up to 0.5% by weight, the main body 10 is free from cracking or fracturing even where the main body 10 is plastically deformed at the tab 22a. That is, even where the tab 22a is bent down over the substantially entire length of the groove 20, as described above, the bent portion 22a does not suffer from cracking or fracturing. This fracture-free, plastic deformation of the main body 10 or the bent portion 22a permits the heat pipe 2 to be fixed directly to the main body 10, with the inner surface of the groove 20 held in contact over a substantially entire length thereof with at least a half of the circumference of the pipe 2. The thus constructed heat transfer assembly is capable of transferring the heat between the heat pipe 2 and the main body 10 with a minimum loss of heat, owing to the large contact surface area between the heat pipe 2 and the main body 10, thereby exhibiting an outstandingly improved heat dissipating performance. Further, this arrangement, in which the heat pipe 2 is attached directly to the main body 10 without use of a retainer plate or any other additional component interposed therebetween, contributes to reduction of the number of the required components, thereby resulting in compact overall construction of the assembly. Still further, this arrangement advantageously increases the freedom in selecting the position at which the heat pipe 2 is to be fixed to the main body 10, and makes it possible to easily attach the heat pipe to the main body 10 even where a space is not available adjacent to the selected position in the main body 10 for the attachment of the retainer plate thereto.

Table 1 shows a result of a test conducted by the inventors of the present invention. In the test, there were prepared ten specimen bodies each of which was identical in its shape to the above-described main body 10 of the heat sink 6. The ten specimen bodies were constituted by respective die-castings which were formed of different castable aluminum alloys No. 1-10 as shown in Table 1. Each specimen body was caulked or bent at a portion thereof onto a heat pipe. The test revealed that the specimen bodies formed of the castable aluminum alloys No. 4-10 each having a content of silicon higher than 0.5% by weight cracked or fractured at the bent portion, resulting in difficulty in firmly fixing the heat pipe to the specimen body. In Table 1, “Fair” in “Plastic deformability” represents that the specimen body was satisfactorily caulked or bent at a portion thereof without cracking or fracturing, while “Poor” in “Plastic deformability” represents that the specimen body suffered from cracking or fracturing at the caulked or bent portion.

TABLE 1

| | | | | Plastic |
|---|---|---|---|---|
| | Chemical Component (wt %) | | | deform- |
| | Si | components other than Si, Al | Al | ability |
| Aluminum | 0.07 | Fe: 1.0 Mn: 2.0 Zn: 2.9 Mg: 0.5 | the | Fair |
| alloy No. 1 | | | rest | |
| Aluminum | 0.10 | Fe: 0.25 Cu: 0.03 Mn: 1.2-1.6 | the | Fair |
| alloy No. 2 | | Ti: 0.03-0.08 W: 0.05-0.1 | rest | |
| Aluminum | 0.06 | Fe: 0.15 Cu: 0.003 Mn: 1.0 | the | Fair |
| alloy No. 3 | | Zn: 0.39 Ni: 0.01 Ti: 0.05 | rest | |
| Aluminum | 0.59 | Fe: 0.14 Cu: 0.09 Mn: 0.98 | the | Poor |
| alloy No. 4 | | Mg: 0.01 Zn: 0.24 Ni: 0.01 | rest | |
| | | Ti: 0.04 | | |
| Aluminum | 11.0- | Fe: 1.3 Cu: 1.0 Mn: 0.3 Mg: 0.3 | the | Poor |
| alloy No. 5 | 13.0 | Zn: 0.5 Ni: 0.5 Sn: 0.1 | rest | |
| Aluminum | 9.0- | Fe: 1.3 Cu: 1.0 Mn: 0.3 Mg: | the | Poor |
| alloy No. 6 | 10.0 | 0.4-0.6 Zn: 0.5 Ni: 0.5 | rest | |
| | | Sn: 0.1 | | |
| Aluminum | 7.5- | Fe: 1.3 Cu: 2.0-4.0 Mn: 0.5 | the | Poor |
| alloy No. 7 | 9.5 | Mg: 0.3 Zn: 1.0 Ni: 0.5 Sn: 0.3 | rest | |
| Aluminum | 9.6- | Fe: 1.3 Cu: 1.5-3.5 Mn: 0.5 | the | Poor |
| alloy No. 8 | 12.0 | Mg: 0.3 Zn: 1.0 Ni: 0.5 Sn: 0.3 | rest | |
| Aluminum | 6.5- | Cu: 1.0-1.5 Mg: 0.3-0.7 | the | Poor |
| alloy No. 9 | 7.5 | | rest | |
| Aluminum | 4.5- | Fe: lower than or equal to 0.2 | the | Poor |
| alloy No. 10 | 5.5 | Mg: 0.3-0.5 | rest | |

In the heat transfer assembly shown in FIGS. 1(a)-(d), the heat pipe 2 is attached to also the heat absorbing member in the form of the heat absorbing block 4, by plastically deforming the heat absorbing block 4. Described more specifically, the heat absorbing block 4 has a generally rectangular plate-like shape and is constituted by an aluminum-based die-casting which is formed of a castable aluminum alloy having a silicon content of up to 0.5% by weight, like the body portion 10 of the heat sink 6. The heat absorbing block 4 has a groove 24 formed in a peripheral surface 25 thereof so as to extend over a predetermined length along a substantially rectangular periphery of the heat absorbing block 4. Like the groove 20, the groove 24 consists of two straight portions and a curved portion which connects these two straight portions, and accordingly has a generally J or L shape as viewed in the plan view of FIG. 1(a). The groove 24 has a U shape in its transverse cross section, namely, a semi-circular bottom shape which corresponds to a circular outer circumferential shape of the heat pipe 2. The opposite two sides or arms of the U shape of the groove 24 are provided by respective side walls which are respectively constituted by tabs 26a, 26b. These tabs 26a, 26b have end faces provided by the peripheral surface 25 of the heat absorbing block 4, and extend along the peripheral surface 25, so as to define the groove 24. Thus, each of the opposite side walls defining the groove 24 is constituted by a corresponding one of the tabs 26a, 26b. The heat pipe 2 is accommodated in the groove 24, and the tabs 26a, 26b are then plastically deformed, namely, bent down onto the heat pipe 2, as shown in FIG. 3(b), so that the heat pipe 2 is fixed at its fixing portion 7a to the heat absorbing block 4 with the inner surface of the groove 24 being in contact with at least a half of the circumference of the pipe 2.

In the present heat transfer assembly, the heat pipe 2 is attached also at its heat absorbing portion 7a to the heat absorbing block 4 by bending down the tabs 26a, 26b into heat conducting and pressing contact with the heat pipe 2 such that the heat pipe 2 is firmly fixed to the heat absorbing block 4 as well as to the heat sink 6. The heat transfer assembly is capable of effectively transferring the heat between the heat pipe 2 and the heat absorbing block 4 as well as between the heat pipe 2 and the heat sink 6, thereby significantly contributing to an improvement in the efficiency of the heat transfer achieved by the heat pipe 2.

As described above, the heat pipe 2 can be attached not only to the heat dissipating member in the form of the heat sink 6 but also to the heat absorbing member in the form of the heat absorbing block 4, by plastically deforming the tabs 22a, 26a, 26b. That is, the principle of the present invention is advantageously applicable to an assembly wherein at least one of the heat conductive members, i.e., either or both of the heat absorbing block 4 and the heat sink 6 is/are attached to the heat pipe 2.

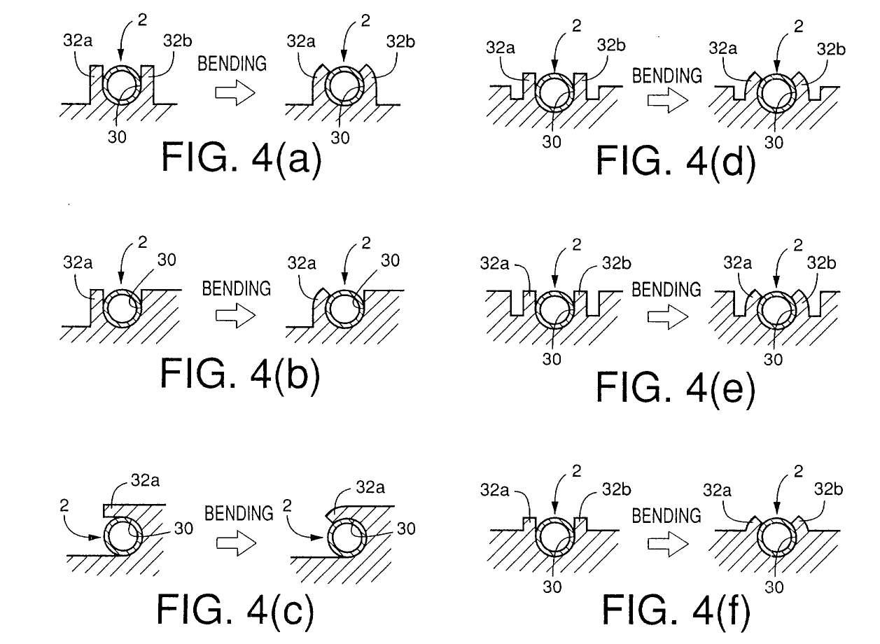

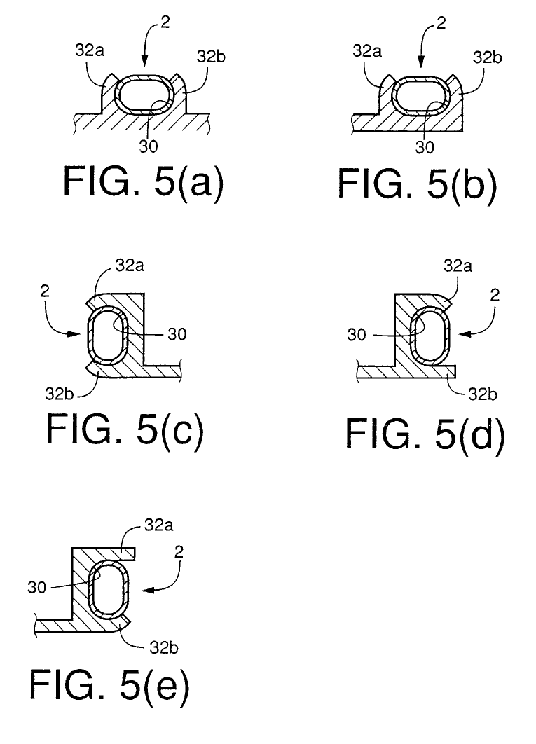

While the preferred embodiment of this invention has been described above in detail by reference to FIGS. 1-3, it is to be understood that the present invention may be embodied with various changes and modifications as shown in FIGS. 4(a)-(f) and FIGS. 5(a)-(e).

For instance, each U-shaped groove for accommodating the heat pipe 2 therein may be formed in a die casting process and additionally a machining process which is effected simultaneously with or after the die casting process, so as to have a desired shape or configuration, as indicated at 30 in FIGS. 4 and 5. Two tabs 32a, 32b may be formed so as to provide both of the opposite side walls of the groove 30. The two tabs 32a, 32b are bent down onto the heat pipe 2 accommodated in the groove 30. Alternatively, only one tab 32a may be formed so as to provide one of the opposite side walls of the groove 30, and the tab 32a is bent down onto the heat pipe 2 accommodated in the groove 30. In either case, the heat pipe 2 is fixed to the heat conductive member such that the inner surface of the groove 30 is held in contact with at least a half of the outer circumferential surface of the heat pipe 2.

FIGS. 4(a), (d), (e) and (f) show various modified examples in which the tabs 32a, 32b are formed to provide both of the opposite side walls defining the groove 30. FIGS. 4(b) and (c) show modified examples in which only one tab 32a is formed to provide one of the opposite side walls defining the groove 30. That is, the two tabs 32a, 32b are bent down into contact with the heat pipe 2 in each of the modified examples of FIGS. 4(a), (d), (e) and (f), while the single tab 32a is bent down into contact with the heat pipe 2 in each of the modified examples of FIGS. 4(b) and (c). Also in each of these examples, the heat pipe 2 is held fixed to the heat conductive member, with the inner surface of the groove 30 being in contact over a substantially entire length thereof with at least a half of the outer circumferential surface of the heat pipe 2.

In the above-described embodiment and modified examples, each groove (20, 24, 30) formed in the heat conductive member (4, 6) has the semi-circular bottom shape, since the heat pipe (2) to be accommodated in the groove (20, 24, 30) has the circular outer circumferential shape in its transverse cross section. However, the bottom of the groove (20, 24, 30) may be otherwise shaped depending upon the outer circumferential shape of the heat pipe (2). FIGS. 5(a)-(e) show modified examples in which the groove 30 has an elliptic bottom shape for accommodating therein the heat pipe 2 having an elliptic shape in its transverse cross section.

While the heat pipe 2 and the heat conductive member 4, 6 are fixed to each other without an additional component interposed therebetween in the above-illustrated embodiment and modified examples, it is also possible to interpose a grease, a heat conductive sheet, an insulator, or other additional component between the heat pipe 2 and the inner surface of the U-shaped groove 20, 24, 30, if needed.

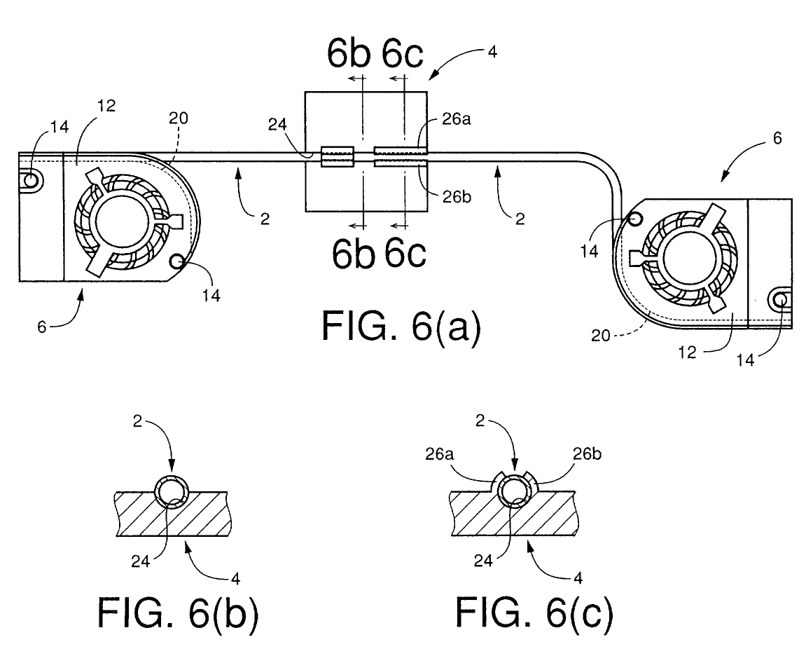

The specific position at which the heat pipe 2 is attached to the heat conductive member 4, 6 is not limited to that in the illustrated embodiment of FIGS. 1-3 wherein the heat pipe 2 is attached at its fixing end portion 7a, 7b to the outer circumferential surface of the heat conductive member 4, 6. For example, as another embodiment of the present invention shown in FIG. 6(a), the heat pipe 2 may be attached in its central fixing portion to the heat conductive member (heat absorbing block 4) such that the central fixing portion of the heat pipe 2 is held by the tabs 26a, 26b bent down onto the heat pipe 2. In this case, each of the tabs 26a, 26b protrudes over a predetermined distance from the surface in which the groove 24 is formed. The tabs 26a, 26b may be formed throughout the entire length of the groove 24 formed in the heat absorbing block 4, or alternatively, the tabs 26a, 26b may be formed along the groove 24 but not over the entire length of the groove 24 such that a part of the central portion of the heat pipe 2 is held by the bent tabs 26a, 26b.

While the embodiments of the present invention have been described above for illustrative purpose only, it is to be understood that the present invention is not limited to the details of the above-described embodiments but may be embodied with various changes, modifications and improvements, which may occur to those skilled in the art, without departing from the spirit and scope of the present invention defined in the following claims:

What is claimed is:

1. An assembly comprising at least one heat conductive member each constituted by an aluminum-based die-casting, and a heat pipe attached at a fixing portion thereof to said heat conductive member over a predetermined length, wherein the improvement comprises;
said aluminum-based die-casting being formed of a castable aluminum alloy which includes up to 0.5% by weight of silicon;
said heat conductive member having a groove formed in a surface thereof; and
said heat pipe being accommodated at said fixing portion in said groove, and being held fixed at said fixing portion in said groove by plastically deforming at least one of opposite side walls defining said groove, toward an outer circumferential surface of said heat pipe.

2. An assembly according to claim 1, wherein said groove has a bottom shape corresponding to a shape of said circumferential surface of said heat pipe such that an inner surface of said groove is held in contact with said outer circumferential surface of said heat pipe over at least a half of a circumference of said heat pipe.

3. An assembly according to claim 1, wherein each of said at least one of opposite side walls of said groove is constituted by a tab which is bent down onto said outer circumferential surface of said heat pipe.

4. An assembly according to claim 1, wherein said at least one heat conductive member comprises a heat absorbing member.

5. An assembly according to claim 1, wherein said at least one heat conductive member comprises a heat dissipating member.

6. An assembly according to claim 1, wherein said heat conductive member comprises a heat absorbing member and a heat dissipating member.

7. An assembly according to claim 5, wherein said heat dissipating member is a heat sink.

8. An assembly according to claim 7, wherein said heat sink has a generally plate-like shape and a peripheral surface which defines a periphery of said plate-like shape, and wherein said groove is formed in said peripheral surface and extends over a predetermined length along said periphery.

9. An assembly according to claim 1, wherein said castable aluminum alloy includes up to 0.1% by weight of silicon.

10. A method of manufacturing an assembly including a heat conductive member constituted by an aluminum-based die-casting, and a heat pipe attached at a fixing portion thereof to said heat conductive member over a predetermined length, said method comprising;
a step of preparing said heat conductive member by forming said aluminum-based die-casting of a castable aluminum alloy such that said heat conductive member has a groove in a surface of said heat conductive member, said castable aluminum alloy including up to 0.5% by weight of silicon;
a step of preparing said heat pipe;
a step of accommodating said heat pipe at said fixing portion in said groove; and
a step of plastically deforming at least one of opposite side walls defining said groove, toward an outer circumferential surface of said heat pipe, so that heat pipe and said heat conductive member are fixed to each other so as to provide said assembly.

11. A method according to claim 10, wherein said groove has a bottom shape corresponding to a shape of said circumferential surface of said heat pipe such that an inner surface of said groove is held in contact with said outer circumferential surface of said heat pipe over at least a half of a circumference of said heat pipe.

12. A method according to claim 10, further comprising a step of forming a tab at at least one of opposite edges of said groove such that said tab protrudes over a predetermined distance from said surface in which said groove is formed, so that said at least one of said opposite side walls is constituted by said tab, and wherein said tab is bent down onto said outer circumferential surface of said heat pipe.

13. A method according to claim 10, wherein said heat conductive member has a generally plate-like shape and a peripheral surface which defines a periphery of said plate-like shape, and wherein said groove is formed in said peripheral surface and extends over a predetermined length along said periphery.

14. A method according to claim 10, wherein said castable aluminum alloy includes up to 0.1% by weight of silicon.

15. A method of according to claim 10, further comprising a step of machining said groove in said surface of said heat conductive member.
